(19) United States
(12) Patent Application Publication
(10) Pub. No.: US 2016/0224657 A1
(43) Pub. Date: Aug. 4, 2016

(54) DIGITIZED INTERACTIONS WITH AN IDENTIFIED OBJECT

(71) Applicant: Brian Mullins, Sierra Madre, CA (US)

(72) Inventor: Brian Mullins, Sierra Madre, CA (US)

(73) Assignee: LLC DAQRI, LLC, Los Angeles, CA (US)

(21) Appl. No.: 15/006,843

(22) Filed: Jan. 26, 2016

Related U.S. Application Data
(60) Provisional application No. 62/110,259, filed on Jan. 30, 2015.

(51) Int. Cl. G06F 17/30

(52) U.S. Cl. CPC G06F 17/30601; G06F 17/30572; G06F 17/30864

(57) ABSTRACT

Techniques of providing digitized interactions with identified objects are disclosed. In some embodiments, sensor data of an object can be received. The sensor data may have been captured by a computing device of a user. A category of the object can be identified based on at least one characteristic of the object from the sensor data. A characterizing feature of the category of the object can be determined. Virtual content can be generated based on the characterizing feature. The virtual content can be caused to be displayed concurrently with a view of the object on a display screen of the computing device.

### REFERENCE TO RELATED APPLICATION

This application claims the benefit of U.S. Provisional Application No. 62/110,259, filed Jan. 30, 2015, which is hereby incorporated by reference in its entirety.

### TECHNICAL FIELD

The present application relates generally to the technical field of data processing, and, in various embodiments, to methods and systems of digitized interactions with identified objects.

### BACKGROUND

Augmented reality is a live, direct or indirect, view of a physical, real-world environment whose elements are augmented by computer-generated sensory input, such as sound, video, graphics, or GPS data. Currently, the capabilities of augmented reality is limited by reliance on predefined virtual content being specifically configured for and assigned to a specific object that a user of the augmented reality application is encountering. Current augmented reality solutions lack the ability to recognize an object that a creator or administrator of the augmented reality solution has not already defined, as well as the ability to provide virtual content that a creator or administrator of the augmented reality solution has not already assigned to an object, thereby limiting the interaction between augmented reality applications and real-world objects.

### BRIEF DESCRIPTION OF THE DRAWINGS

Some example embodiments of the present disclosure are illustrated by way of example and not limitation in the figures of the accompanying drawings, in which like reference numbers indicate similar elements, and in which:

FIG. 1 is a block diagram illustrating an augmented reality system, in accordance with some example embodiments;

FIG. 2 illustrates a use of an augmented reality system, in accordance with some example embodiments;

FIG. 3 illustrates another use of an augmented reality system, in accordance with some example embodiments;

FIG. 4 is a flowchart illustrating a method of providing a digitized interaction with an object, in accordance with some embodiments;

FIG. 5 is a flowchart illustrating a method of generating virtual content, in accordance with some embodiments;

FIG. 6 illustrates a method of providing a digitized interaction with an object, in accordance with some embodiments;

FIG. 7 is a block diagram illustrating a head-mounted display device, in accordance with some example embodiments.

FIG. 8 is a block diagram of an example computer system on which methodologies described herein may be executed, in accordance with some example embodiments; and

FIG. 9 is a block diagram illustrating a mobile device, in accordance with some example embodiments.

### DETAILED DESCRIPTION

Example methods and systems of providing digitized interactions for with identified objects are disclosed. In the following description, for purposes of explanation, numerous specific details are set forth in order to provide a thorough understanding of example embodiments. It will be evident, however, to one skilled in the art that the present embodiments may be practiced without these specific details.

The present disclosure provides techniques that enable an augmented reality system or device to programmatically associate content with non-previously catalogued objects or environmental elements, thereby allowing the augmented reality system or device to scale unconstrained by active human publishing activity or indexing in recognition databases. Accordingly, the techniques of the present disclosure can provide virtual content for an object or environment in situations where the object or environment and corresponding virtual content have not been specifically predefined or associated with each other within an augmented reality system or within another system accessible to the augmented reality system. For example, a user using the augmented reality system can encounter a specific real-world object that has not been predefined within the augmented reality system, meaning there is neither a stored identification of that specific real-world object nor a stored virtual content for that specific real-world object. However, the augmented reality system can still identify what kind of object the real-world object is (e.g., the category of the object) based on one or more characteristics of the object, and then determine and display virtual content based on that identification.

In some example embodiments, image, depth, audio, and/or other sensor data of an object is received. The sensor data can be captured actively or passively through a variety of form factors. A category of the object can be identified based on at least one characteristic of the object from the data. Virtual content is generated based on the characterizing feature (as opposed to being derived from a discrete, single recognition). The virtual content is then associated with the object in physical space and tracked (held in a known relationship in physical space) as the user moves through the environment and interacts with the object.

In some example embodiments, the characteristic(s) of the object can comprise at least one of a shape, size, color, orientation, temperature, material composition, or any other characteristic identifiable by one or more sensors on the viewing device. The virtual content is caused to be displayed on a display screen of the computing device. Causing the virtual content to be displayed can comprise overlaying the view of the object with the virtual content. The user computing device can comprise one of a smart phone, a tablet computer, a wearable computing device, a head-mounted display device, a vehicle computing device, a laptop computer, a desktop computer, or other hand held or wearable form factors. Any combination of one or more of the operations of receiving the sensor data, identifying the characteristic or category of the object, determining the characterizing feature(s), selecting and generating the virtual content, and causing the virtual content to be displayed can be performed by a remote server separate from the computing device.

In some example embodiments, identifying the category of the object can comprise performing a machine learning process. Performing the machine learning process can comprise performing lookup within publicly available third party databases, not previously connected to or part of the augmented reality system disclosed herein, based on the at least one characteristic of the object.

In some example embodiments, determining the characterizing feature can comprise performing a machine learning process. Performing the machine learning process can include, but is not limited to, public content crawling or indexing based on the category of the object. For example, publicly accessible web sites or file systems comprising public content (e.g., visual data, text) can be crawled as part of the machine learning process.

In some example embodiments, generating the virtual content can comprise performing a machine learning process.

In some example embodiments, generating the visual content can comprise determining a software application based on the category of the object, where the software application managing user content configured by the user, retrieving the user content from the software application, and generating the virtual content based on the retrieved user content. The virtual content can comprise the retrieved user content.

In some example embodiments, visual content that is disposed on the object can be identified based on the sensor data. A software application can be determined based on the category or characteristic of the object. The software application can be accessible by the user on the computing device or may be accessed or downloaded from a server-side resource. Data corresponding to the visual content can be provided to the software application for use by the software application in modifying application content of the software application.

The methods or embodiments disclosed herein may be implemented as a computer system having one or more modules (e.g., hardware modules or software modules). Such modules may be executed by one or more processors of the computer system. One or more of the modules can be combined into a single module. In some example embodiments, a non-transitory machine-readable storage device can store a set of instructions that, when executed by at least one processor, causes the at least one processor to perform the operations and method steps discussed within the present disclosure.

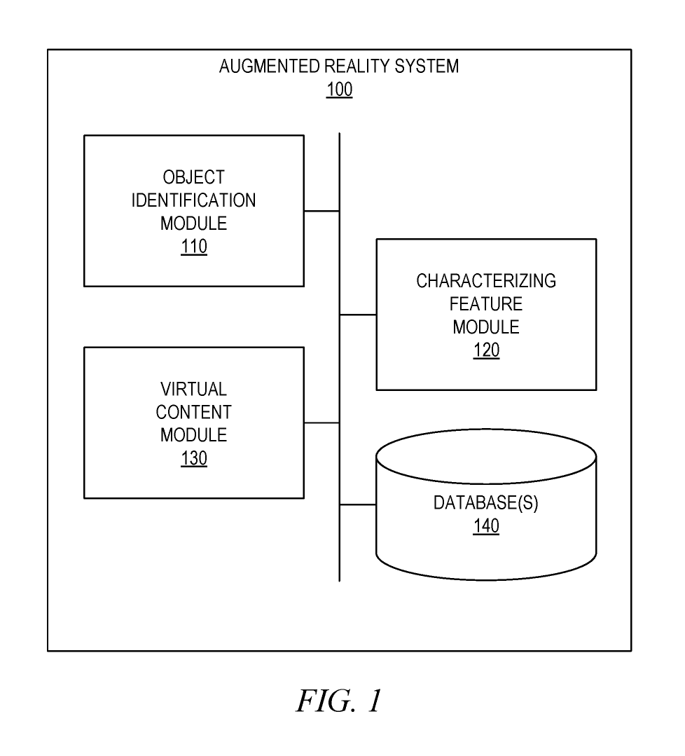

FIG. 1 is a block diagram illustrating an augmented reality system 100, in accordance with some example embodiments. In some embodiments, augmented reality system 100 comprises any combination of one or more of an object identification module 110, a characterizing feature module 120, a virtual content module 130, and one or more database(s) 140.

The object identification module 110 can be configured to receive sensor data of an object. The sensor data may have been captured by a computing device of a user. Examples of such a computing device include, but are not limited to, a smart phone, a tablet computer, a wearable computing device, a head-mounted display device, a vehicle computing device, a laptop computer, a desktop computer, or other hand held or wearable form factors. The computing device can include cameras, depth sensors, inertial measurement units with accelerometers, gyroscopes, magnometers, and barometers, among other included sensors, and any other type of data capture device embedded within these form factors. The sensor data may be used dynamically, leveraging only the elements and sensors necessary to achieve characterization or classification as befits the use case in question. The sensor data can comprise, visual or image data, audio data, or other forms of data.

The object identification module 110 can be further configured to identify a category of the object based on at least one characteristic of the object from the sensor data. Such characteristics can include, but are not limited to, a shape of the object, a size of the object, a color of the object, an orientation of the object, a temperature of the object, a material composition of the object, generic text disposed on the object, a generic visual element disposed on the object, or any other characteristic identifiable by one or more sensors on the computing device. The term “generic” refers to non-discrete related content that applies to a category of an object as opposed to the specific discrete object itself. The phrase “generic text” is used herein to refer to text that relates to or is characteristic of a group or class, as opposed to text that has a particular distinctive identification quality. For example, the text “July” disposed on a calendar is generic, as it simply refers to a month, which can be used to recognize the fact that the text “July” is on a calendar, as opposed to identifying a specific calendar. In contrast, numerical digits of a barcode ID on a product are not generic, as they specifically identify that specific product. Similarly, the phrase “generic physical or visual element” is used herein to refer to an element that relates to or is characteristic of a group or class, as opposed to a visual element that has a particular distinctive identification quality. For example, the organization of horizontal and vertical lines forming the grid of days of the month on the calendar are generic visual elements (or can form a single generic visual element), as they simply form a type of grid, which can then be used to recognize the fact that the grid is on a calendar, as opposed to identifying a specific calendar. In contrast, the group of parallel lines forming a barcode on a product is not generic, as they specifically identify a specific product. In both cases, the features disclosed herein complement existing capabilities of discrete image and object recognition with digital content specific to one object (type), image, location, etc.

The feature of identifying the category of the object is useful, as it can be used to provide virtual content for the object in situations where the object and corresponding virtual content have not been specifically predefined or associated with other within the augmented reality system 100 or within another system accessible to the augmented reality system 100. For example, a user using the augmented reality system 100 can encounter a specific real-world object, such as a specific globe (e.g., specific brand, specific model), that has not been predefined within the augmented reality system 100, meaning there is neither a stored identification of that specific real-world object nor a stored virtual content for that specific real-world object. However, the augmented reality system 100 can still identify what kind of object the real-world object is (e.g., the category of the object) based on one or more characteristics of the object.

In some example embodiments, the object identification module 110 can identify the category of the object using one or more rules. These rules can be stored in database(s) 140 and be used to identify the category of the object based on the characteristic(s) of the object. For example, the rules may indicate that when certain shapes, colors, generic text, and/or generic visual elements are grouped together in a certain configuration, they represent a certain category of object. In one example, the database(s) 140 may not comprise actual images of a specific globe with which to compare the received sensor data or a mapping of a barcode that identifies that specific globe, but rather rules defining what characteristics constitute a globe (e.g., spherical shape, certain arrangement of outlines of geographical shapes, the use of certain colors such as blue).

In some example embodiments, the object identification module 110 can identify the category of the object by performing a machine learning process. Performing the machine learning process can include a search or lookup within an external database or resource based on the characteristic(s) of the object. The third party or public data source access and indexing can serve to create and improve categories or characteristic definitions, which can then be combined with the sensor data to form a more complete and evolving definition of the categories or characteristics. The category can be identified using active processing or passive lookup of category identification information associated with the corresponding data set. For example, existing metadata of the results can be used to create a keyword index that instantiates or improves an object category or characteristic description.

The characterizing feature module 120 can be configured to determine a characterizing feature of the category of the object. The characterizing feature can comprise any function, quality, or property that is common among objects of the category. For example, a characterizing feature of the category of a globe can be the representation of water (e.g., oceans) on a globe. As another example, a characterizing feature of a calendar can be the representation of days of the month within which events (e.g., meetings, appointments, notes) can be entered.

In some example embodiments, a mapping of categories to one or more of their corresponding characterizing features can be stored in the database(s) 140, and then accessed by the characterizing feature module 120 to determine the characterizing feature for the category. In other example embodiments, the characterizing feature module 120 can be configured to determine the characterizing feature by performing a machine learning process. Performing the machine learning process can comprise performing an Internet search based on the category of the object, such as using the category as a search query. The characterizing feature module 120 can analyze the search results to find one or more common features associated with the category based on an evaluation of text-based descriptions or visual depictions of the features in the search results.

The virtual content module 130 can be configured to generate virtual content based on the characterizing feature. In some example embodiments, a mapping of characterizing features to corresponding virtual content can be stored in the database(s) 140, and then accessed by the virtual content module 130 to generate the virtual content. In other example embodiments, the virtual content module 130 can be configured to generate the virtual content by performing a machine learning process. Performing the machine learning process can comprise performing crawl or lookup of existing and/or public datasets based on the characterizing feature, such as using the characterizing feature as a search query. The virtual content module 130 analyzes the results to find common virtual content or applications associated with the characterizing feature, which can then be used as a basis for generating the virtual content for the object.

The virtual content module 130 can be configured to cause the virtual content to be displayed concurrently with a view of the object on a display screen of the computing device. The virtual content module 130 can cause the virtual content to be displayed such that the virtual content overlays or maintains a fixed or dynamic spatial relationship to the position of the object.

In some example embodiments, any combination of one or more of the modules or operations of the augmented reality system 100 can reside or be performed on the computing device of the user (e.g., the mobile device or wearable device being used to capture the sensor data of the object).

In some example embodiments, any combination of one or more of the modules or operations of the augmented reality system 100 can reside or be performed on a remote server separate from the computing device of the user. In such a separated configuration, communication of data between the computing device of the user and components of the remote augmented reality system 100 can be achieved via communication over a network. Accordingly, the augmented reality system 100 can be part of a network-based system. For example, the augmented reality system 100 can be part of a cloud-based server system. However, it is contemplated that other configurations are also within the scope of the present disclosure. The network may be any network that enables communication between or among machines, databases, and devices. Accordingly, the network may be a wired network, a wireless network (e.g., a mobile or cellular network), or any suitable combination thereof. The network may include one or more portions that constitute a private network, a public network (e.g., the Internet), or any suitable combination thereof.

In some example embodiments, certain components of the augmented reality system 100 can reside on a remote server that is separate and distinct from the computing device of the user, while other components of the augmented reality system 100 can be integrated into the computing device of the user. Other configurations are also within the scope of the present disclosure.

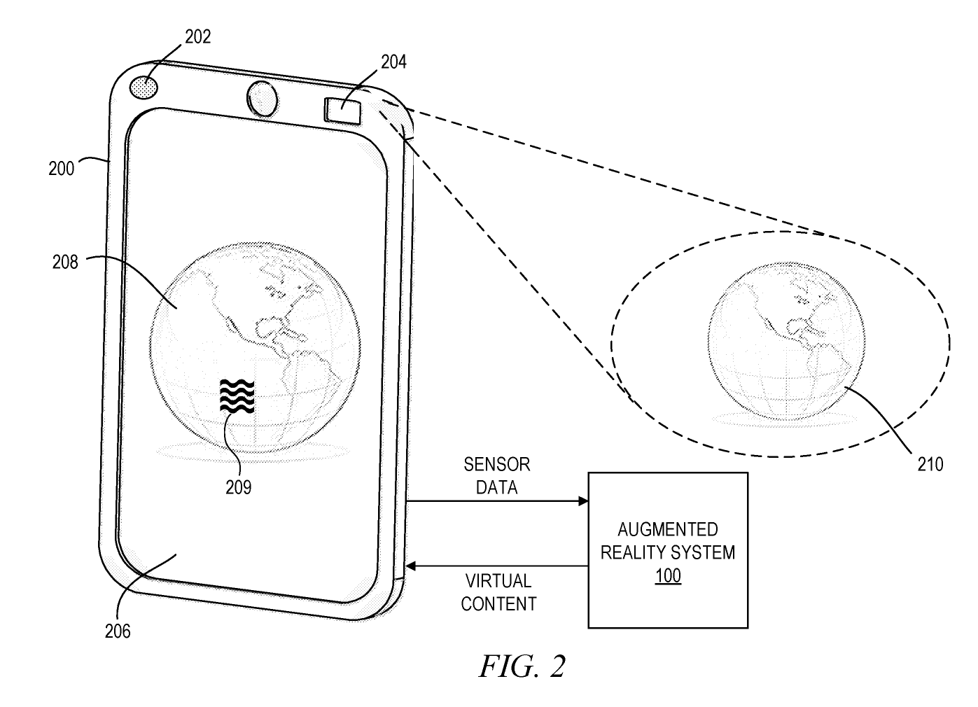

FIG. 2 illustrates a use of the augmented reality system 100, in accordance with some example embodiments. In FIG. 2, a computing device 200 is being used by a user. As previously discussed, the computing device 200 can comprise a smart phone, a tablet computer, a wearable computing device, a vehicle computing device, a laptop computer, or a desktop computer. Other types of computing devices 200 are also within the scope of the present disclosure.

The computing device 200 can comprise an image capture device 204, such as a built-in camera and/or other sensor package, configured to capture environmental data, including the objects 210 in question. The computing device 200 can also comprise a display screen 206 on which a view 208 of the object 210 can be presented. The display screen 206 may comprise a touchscreen configured to receive a user input via a contact on the touchscreen. Although, other types of display screens 206 are also within the scope of the present disclosure. In some embodiments, the display screen 206 is configured to display the captured sensor data as the view of the object 210. In some embodiments, the display screen 206 is transparent or semi-opaque so that the user can see through the display screen 206. The computing device 200 may also comprise an audio output device 202, such as a built-in speaker, through which audio can be output.

In the example of FIG. 2, the object 210 is a globe. The image capture device 204 can be used to capture sensor data of the object 210. The captured sensor data can be displayed on the display screen 206 as the view 208 of the object 210. The computing device 200 can provide the sensor data to the augmented reality system 100, which can be integrated partially or wholly with the computing device 200 or reside partially or wholly on a remote server (not shown) separate from the computing device 200.

As previously discussed, the augmented reality system 100 can receive the captured sensor data of the object 210, and then identify a category of the object 210 based on at least one characteristic of the object 210 from the sensor data. In this example, the augmented reality system 100 can identify the category of the object 210 as a globe based on the spherical shape of the object 210, the geographic outlines on the object 210, and presence of the color blue on the object 210. The augmented reality system 100 can then determine a characterizing feature of the category of the object 210. The augmented reality system 100 can then generate virtual content 209 based on the characterizing feature, which can then be displayed concurrently with the view 208 of the object 210 on the display screen 206 of the computing device 200. In this example, the virtual content 209 can comprise a ripple effect or waves for a portion of the globe representing water or label continents or countries without specific knowledge of the globe being viewed based on a generic dataset.

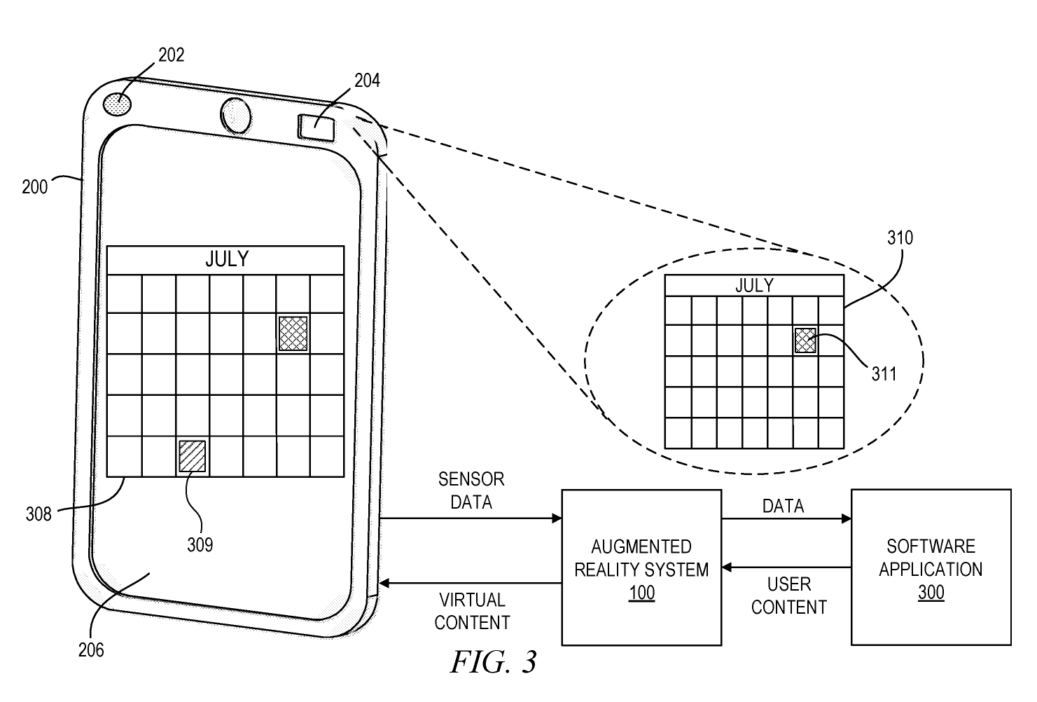

FIG. 3 illustrates another use of an augmented reality system 100, in accordance with some example embodiments. In the example of FIG. 3, the computing device 200 is being used to view an object 310, which is a calendar in this example. The image capture device 204 can be used to capture sensor data of the object 310. The captured sensor data can be displayed on the display screen 206 as the view 308 of the object 310. The computing device 200 can provide the sensor data to the augmented reality system 100, which can be integrated partially or wholly with the computing device 200 or reside partially or wholly on a remote server (not shown) separate from the computing device 200.

As previously discussed, the augmented reality system 100 can receive the captured sensor data of the object 310, and then identify a category of the object 310 based on at least one characteristic of the object 310 from the sensor data. In this example, the augmented reality system 100 can identify the category of the object 310 as a calendar based on the pattern of horizontal and vertical lines forming a grid of days of the month on the object 310, as well as text reading “July”. The augmented reality system 100 can then determine a characterizing feature of the category of the object 310. In this example, the characterizing feature of the calendar can be the representation of days of the month within which events (e.g., meetings, appointments, notes) can be entered.

The augmented reality system 100 can then generate virtual content 309 based on the characterizing feature, which can then be displayed concurrently with the view 308 of the object 310 on the display screen 206 of the computing device 200. In this example, the virtual content 309 can comprise an indication of a scheduled event for a day of the month on the calendar.

In some example embodiments, the virtual content 309 can be generated based on data retrieved from another software application that manages content. Referring back to FIG. 1, the virtual content module 130 can be further configured to determine a software application based on the category of the object. For example, the virtual content module 130 can search a list of available software applications (e.g., software applications that are installed on the computing device of the user or that are otherwise accessible by the user or by the computing device of the user) to find a software application that corresponds to the category of the object. A semantic analysis can be performed, comparing the name or description of the software applications with the category in order to find the most appropriate software application. The software application can manage user content configured by the user. The virtual content module 130 can retrieve the user content from the software application, and then generate the virtual content based on the retrieved user content. The virtual content can comprise the retrieved user content.

Referring back to the example in FIG. 3, the augmented reality system 100 can determine an electronic calendar software application based on the category of the object being identified as a calendar. The electronic calendar software application can manage user content, such as appointments or meetings configured for or associated with specific days of the month, and can reside on the computing device 200 or on a remote server that is separate, but accessible, from the computing device 200. The augmented reality system 100 can retrieve data identifying one or more events scheduled for days of the month on the electronic calendar software application. The virtual content 309 can be generated based on this retrieved data. For example, the virtual content 309 can comprise an identification or some other indication of a scheduled event for a particular day on the calendar. In some example embodiments, the virtual content 309 comprises a graphic and/or text (e.g., an identification or details of an event). The virtual content 309 can also comprise a selectable link that, when selected by the user, loads and displays additional content, such as additional details (e.g., location, attendees) of the scheduled event.

Referring back to FIG. 1, the virtual content module 130 can be further configured to identify content that is located on the object based on the sensor data, and then determine a software application based on the category of the object, which can be identified as previously discussed herein. The virtual content module 130 can then provide, to the software application, data corresponding to the identified visual content for user by the software application in modifying application content being managed by the software application.

Referring back to FIG. 3, visual content 311 that is positioned in 3D space relative to the object 310 can be identified by the augmented reality system 100 based on the captured sensor data. In this example, the content 311 can comprise a hand-written identification of an event for a specific day of the month that has been written onto the calendar. A software application can be determined based on the category of the object, as previously discussed herein. In this example, the software application can be an electronic calendar software application. The augmented reality system 100 can provide data corresponding to the visual content 311 to the software application for use by the software application in modifying application content of the software application. For example, the augmented reality system 100 can provide data (e.g., date, time, name of event) corresponding to the hand-written scheduled event on the calendar to an electronic calendar software application of the user, so that the electronic calendar software application can update the electronic calendar based on the data, such as by automatically scheduling the event for the corresponding day or by automatically prompting a user of the electronic calendar software application to schedule the event in the electronic calendar (e.g., asking the user if he or she would like to schedule the event).

In some example embodiments, the sensor data is captured by one or more sensors in the environment (e.g., fixed networked cameras in communication with the augmented reality system 100), or by one or more sensors on robotic devices (e.g., drones) or other smart devices that can be accessed remotely.

In some example embodiments, the augmented reality system 100 is further configured to use human input to refine the process of providing a digitized interaction with an object. For example, in some embodiments, the object identification module 110 is further configured to use human input in its identifying of the category of the object. For example, the object identification module 110 can identify an initial category or set of categories based on the characteristic(s) of the object from the sensor data, and present an indication of that initial category or categories to a human user, such as via display screen 206, along with one or more selectable user interface element with which the user can approve or confirm the identified initial category as being the correct category of the object or select one of the initial categories as being the correct category of the object. In the example shown in FIG. 2, the object identification module 110 can display a prompt on the display screen asking the human user to confirm whether the object is a globe. In response to human user input confirming or selecting an initial category as being the correct category of the object, the object identification module 110 can store a record indicating this confirmation or selection in database(s) 140 for subsequent use when identifying the category of the object (e.g., so the confirmed or selected initial category will be identified for that object if subsequently processed), and then provide the category identification to the characterizing feature module 120. In response to human user input indicating that the initial category or categories are incorrect, the object identification module 110 can store a record indicating the incorrect identification of the initial category or categories for the object in database(s) 140 for subsequent use when identifying the category of the object (e.g., so the initial category or categories will not be identified for that object again during a subsequent interaction between the augmented reality system 100 and the object), and then repeat the process of identifying the category of the object based on the characteristic(s) of the object (e.g., performing another search).

In some example embodiments, the characterizing feature module 120 is further configured to use human user input in its determination of a characterizing feature of the category of the object. For example, characterizing feature module 120 can identify an initial characterizing feature or set of characterizing features of the category, and present an indication of that initial characterizing feature or characterizing features to a human user, such as via display screen 206, along with one or more selectable user interface element with which the user can approve or confirm the determined initial characterizing feature as being the correct characterizing feature of the category or select one of the initial characterizing features as being the correct characterizing feature of the category. In the example shown in FIG. 2, the object identification module 110 can display a prompt on the display screen asking the human user to confirm whether the characterizing feature of the globe is the representation of water. In response to human user input confirming or selecting an initial characterizing feature as being the correct characterizing feature of the category, the characterizing feature module 120 can store a record indicating this confirmation or selection in database(s) 140 for subsequent use when determining the characterizing feature of the category (e.g., so the confirmed or selected initial characterizing feature will be identified for that category if subsequently processed), and then provide the determined characterizing feature to the virtual content module 130. In response to human user input indicating that the initial characterizing feature or characterizing features are incorrect, the characterizing feature module 120 can store a record indicating the incorrect identification of the initial characterizing feature or characterizing features for the category in database(s) 140 for subsequent use when determining the characterizing feature of the category (e.g., so the initial characterizing feature or characterizing features will not be identified for that category again during a subsequent interaction between the augmented reality system 100 and the object), and then repeat the process of determining the characterizing feature of the category (e.g., performing another search).

In some example embodiments, the virtual content module 130 is further configured to use human user input in its generating virtual content based on the characterizing feature. For example, virtual content module 130 can determine an initial virtual content or set of virtual content to generate for the object, and present an indication of that initial virtual content to a human user, such as via display screen 206, along with one or more selectable user interface element with which the user can approve or confirm the determined initial virtual content as being the correct virtual content for the object or select one of the set of virtual content as being the correct virtual content for the object. In the example shown in FIG. 2, the virtual content module 130 can display a prompt on the display screen asking the human user to confirm whether the virtual content for the globe should be waves. In response to human user input confirming or selecting an initial virtual content as being the correct virtual content for the object, the virtual content module 130 can store a record indicating this confirmation or selection in database(s) 140 for subsequent use when determining the virtual content for the object (e.g., so the confirmed or selected virtual content will be identified for that object if subsequently processed), and then generate the virtual content for display to the human user on the display screen. In response to human user input indicating that the virtual content is incorrect, the virtual content module 130 can store a record indicating the incorrect virtual content for the object, category, or characterizing feature in database(s) 140 for subsequent use when determining the virtual content for the object (e.g., so the initial virtual content will not be identified for that object, category, or characterizing feature again during a subsequent interaction between the augmented reality system 100 and the object or an object of the same category or for the same characterizing feature), and then repeat the process of determining the virtual content to display (e.g., performing another search).

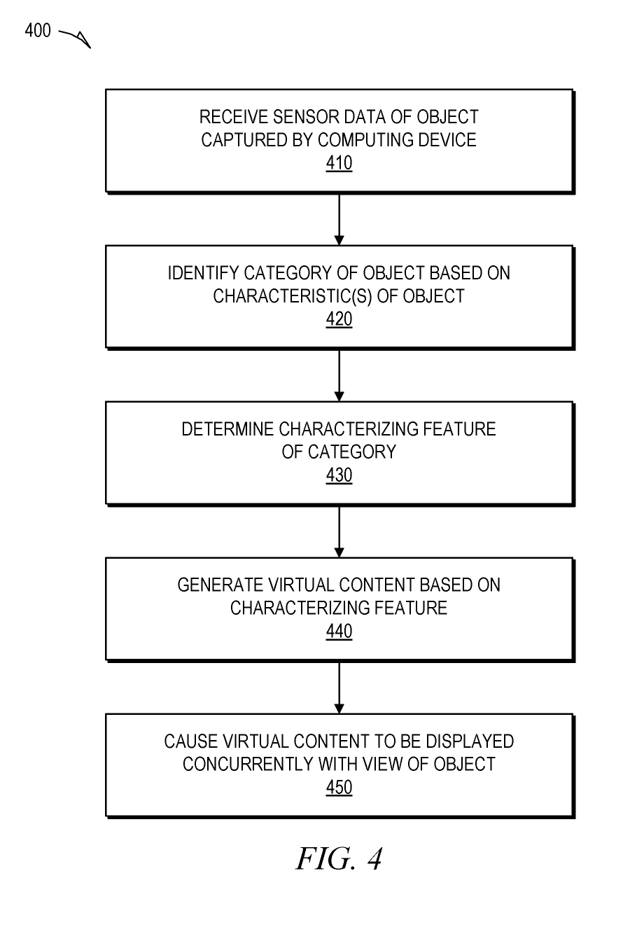

FIG. 4 is a flowchart illustrating a method 400 of providing a digitized interaction with an object, in accordance with some embodiments. Method 400 can be performed by processing logic that can comprise hardware (e.g., circuitry, dedicated logic, programmable logic, microcode, etc.), software (e.g., instructions run on a processing device), or a combination thereof. In one example embodiment, the method 400 is performed by the augmented reality system 100 of FIG. 1, or any combination of one or more of its components or modules, as described above.

At operation 410, sensor data of an object can be received, as previously discussed herein. The sensor data can be captured by a computing device of a user. At operation 420, a category of the object can be identified based on at least one characteristic of the object from the sensor data, as previously discussed herein. At operation 430, a characterizing feature of the category of the object can be determined, as previously discussed herein. At operation 440, virtual content can be generated based on the characterizing feature, as previously discussed herein. At operation 450, the virtual content can be caused to be displayed concurrently with a view of the object on a display screen of the computing device, as previously discussed herein. It is contemplated that any of the other features described within the present disclosure can be incorporated into method 400.

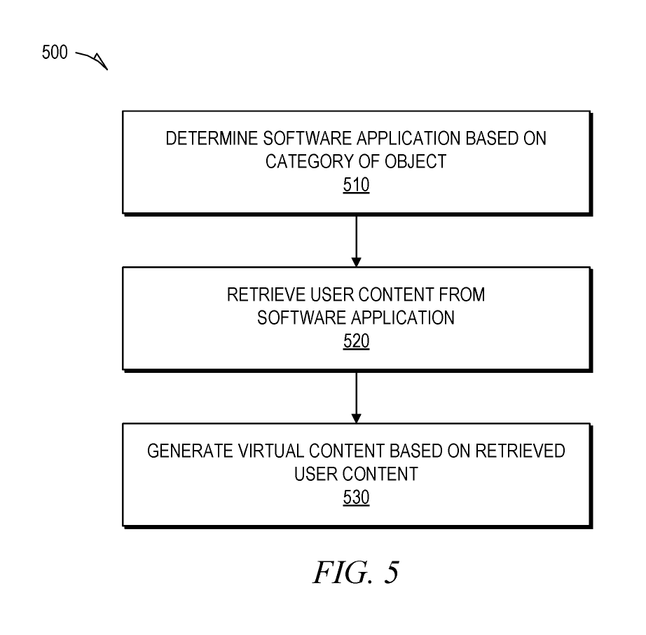

FIG. 5 is a flowchart illustrating a method 500 of generating virtual content, in accordance with some embodiments. Method 500 can be performed by processing logic that can comprise hardware (e.g., circuitry, dedicated logic, programmable logic, microcode, etc.), software (e.g., instructions run on a processing device), or a combination thereof. In one example embodiment, the method 500 is performed by the augmented reality system 100 of FIG. 1, or any combination of one or more of its components or modules, as described above.

At operation 510, a software application can be determined based on the category of the object, as previously discussed herein. The software application can manage user content configured by the user. At operation 520, the user content can be retrieved from the software application, as previously discussed herein. At operation 530, the virtual content can be generated based on the retrieved user content, as previously discussed herein. The virtual content can comprise the retrieved user content. It is contemplated that any of the other features described within the present disclosure can be incorporated into method 500.

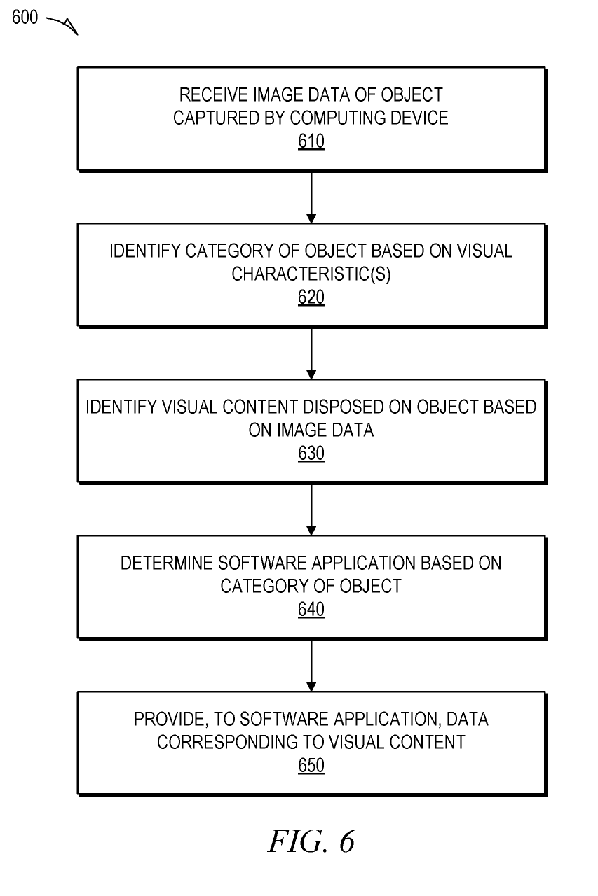

FIG. 6 illustrates a method 600 of providing a digitized interaction with an object, in accordance with some embodiments. Method 600 can be performed by processing logic that can comprise hardware (e.g., circuitry, dedicated logic, programmable logic, microcode, etc.), software (e.g., instructions run on a processing device), or a combination thereof. In one example embodiment, the method 600 is performed by the augmented reality system 100 of FIG. 1, or any combination of one or more of its components or modules, as described above.

At operation 610, sensor data of an object can be received, as previously discussed herein. The sensor data can be captured by a computing device of a user. At operation 620, a category of the object can be identified based on at least one visual characteristic of the object from the sensor data, as previously discussed herein. At operation 630, visual content that is disposed on the object can be identified based on the sensor data, as previously discussed herein. At operation 640, a software application can be determined based on the category of the object, as previously discussed herein. The software application can be accessible by the user on the computing device. At operation 650, data corresponding to the visual content can be provided to the software application for use by the software application in modifying application content of the software application, as previously discussed herein. It is contemplated that any of the other features described within the present disclosure can be incorporated into method 600.

### Example Wearable Device

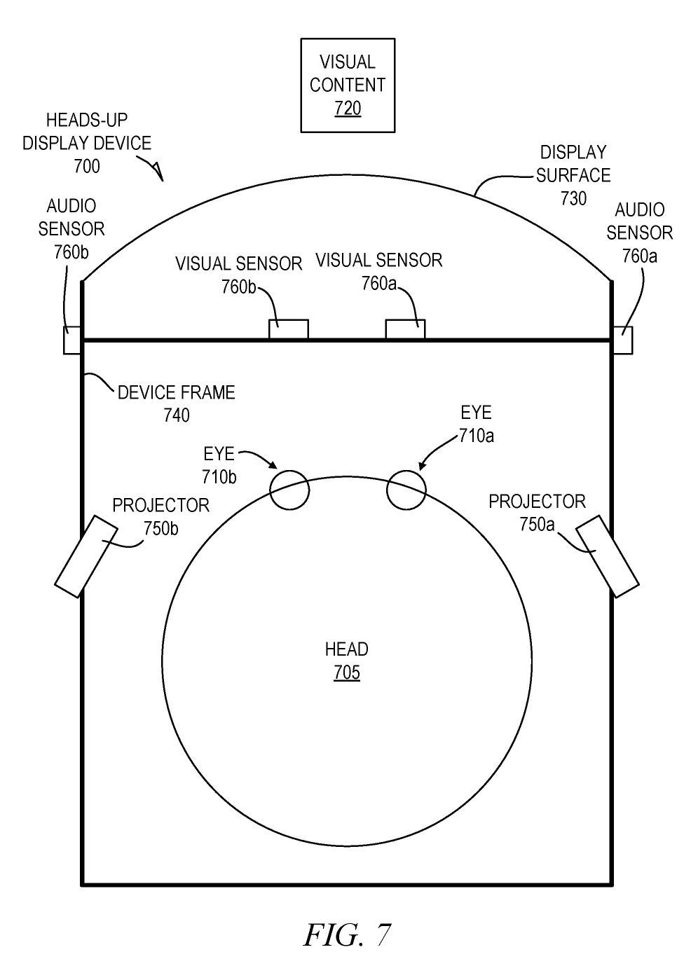

FIG. 7 is a block diagram illustrating a head-mounted display device 700, in accordance with some example embodiments. It is contemplated that the features of the present disclosure can be incorporated into the head-mounted display device 700 or into any other wearable device. In some embodiments, head-mounted display device 700 comprises a device frame 740 to which its components may be coupled and via which the user can mount, or otherwise secure, the heads-up display device 400 on the user's head 705. Although device frame 700 is shown in FIG. 7 having a rectangular shape, it is contemplated that other shapes of device frame 740 are also within the scope of the present disclosure. The user's eyes 710a and 710b can look through a display surface 730 of the head-mounted display device 700 at real-world visual content 720. In some embodiments, head-mounted display device 400 comprises one or more sensors, such as visual sensors 760a and 760b (e.g., cameras) and audio sensors 760a and 760b (e.g., microphones), for capturing sensor data. The head-mounted display device 700 can comprise other sensors as well, including, but not limited to, depth sensors, inertial measurement units with accelerometers, gyroscopes, magnometers, and barometers, and any other type of data capture device embedded within these form factors. In some embodiments, head-mounted display device 700 also comprises one or more projectors, such as projectors 750a and 750b, configured to display virtual content on the display surface 730. Display surface 730 can be configured to provide optical see-through (transparent) ability. It is contemplated that other types, numbers, and configurations of sensors and projectors can also be employed and are within the scope of the present disclosure.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 214 of FIG. 2) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

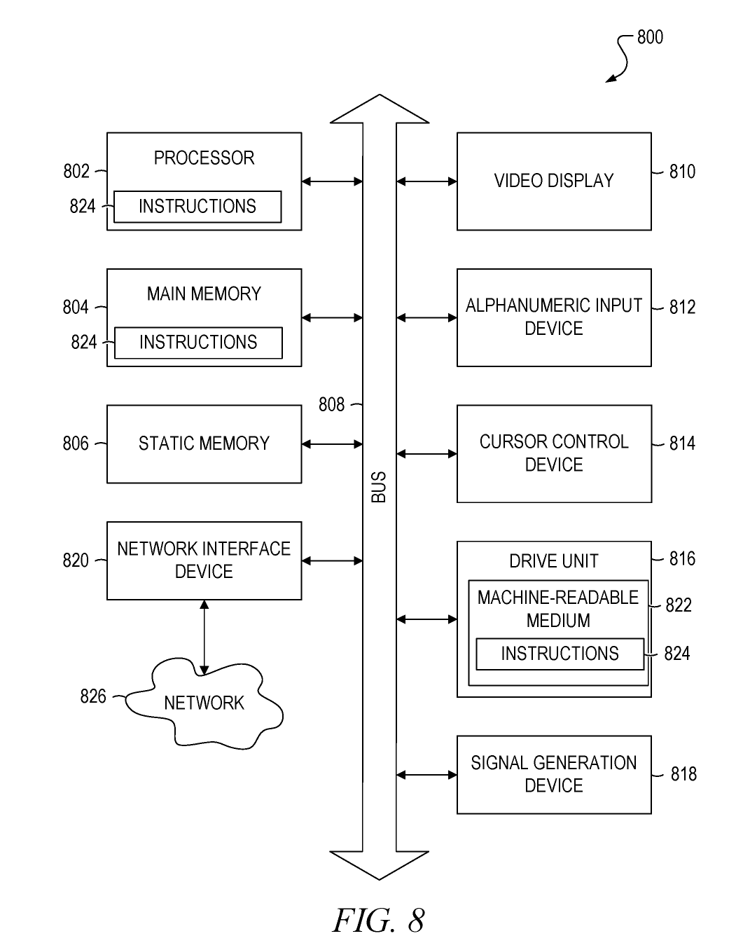

FIG. 8 is a block diagram of a machine in the example form of a computer system 800 within which instructions 824 for causing the machine to perform any one or more of the methodologies discussed herein may be executed, in accordance with an example embodiment. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a smartphone, a tablet computer, a set-top box (STB), a Personal Digital Assistant (PDA), a web appliance, a network router, switch or bridge, a head-mounted display or other wearable device, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 . The computer system 800 may also include an alphanumeric input device 812 (e.g., a keyboard), a user interface (UI) navigation (or cursor control) device 814 (e.g., a mouse), a disk drive unit 816, a signal generation device 818 (e.g., a speaker) and a network interface device 820.

The disk drive unit 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804 and/or within the processor 802 during execution thereof by the computer system 800, the main memory 804 and the processor 802 also constituting machine-readable media. The instructions 824 may also reside, completely or at least partially, within the static memory 806.

While the machine-readable medium 822 is shown in an example embodiment to be a single medium, the term “machine-readable medium” may include a single medium or multiple media (e.g., a centralized or distributed database, and/or associated caches and servers) that store the one or more instructions 824 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

### Example Mobile Device

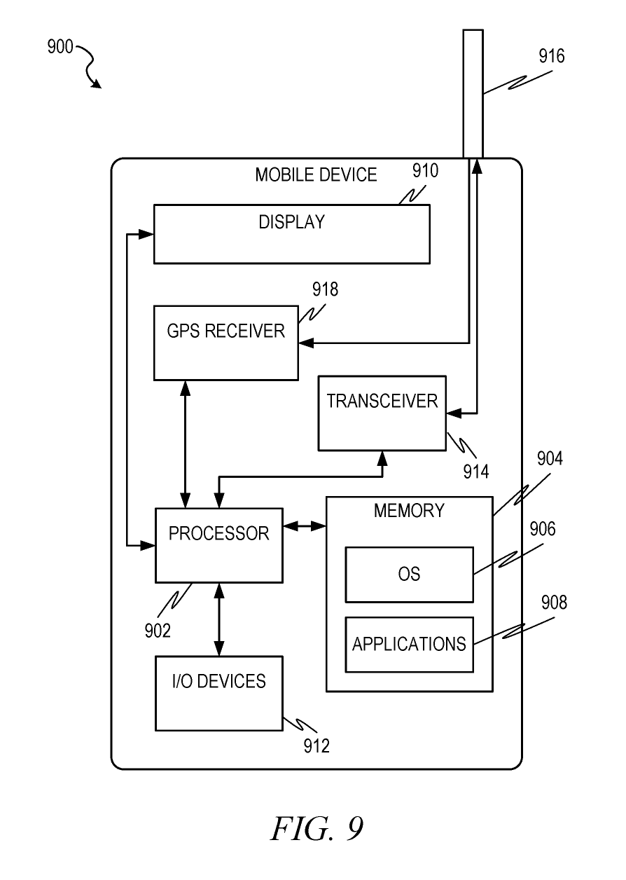

FIG. 9 is a block diagram illustrating a mobile device 900, according to an example embodiment. The mobile device 900 may include a processor 902. The processor 902 may be any of a variety of different types of commercially available processors 902 suitable for mobile devices 900 (for example, an XScale architecture microprocessor, a microprocessor without interlocked pipeline stages (MIPS) architecture processor, or another type of processor 902). A memory 904, such as a random access memory (RAM), a flash memory, or other type of memory, is typically accessible to the processor 902. The memory 904 may be adapted to store an operating system (OS) 906, as well as application programs 908, such as a mobile location enabled application that may provide LBSs to a user 102. The processor 902 may be coupled, either directly or via appropriate intermediary hardware, to a display 910 and to one or more input/output (I/O) devices 912, such as a keypad, a touch panel sensor, a microphone, and the like. Similarly, in some embodiments, the processor 902 may be coupled to a transceiver 914 that interfaces with an antenna 916. The transceiver 914 may be configured to both transmit and receive cellular network signals, wireless data signals, or other types of signals via the antenna 916, depending on the nature of the mobile device 900. Further, in some configurations, a GPS receiver 918 may also make use of the antenna 916 to receive GPS signals.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented method comprising:
receiving sensor data of an object, the sensor data having been captured by a computing device of a user;
identifying, by a machine having a memory and at least one processor, a category of the object based on at least one characteristic of the object from the sensor data;
determining a characterizing feature of the category of the object;
generating virtual content based on the characterizing feature; and
causing the virtual content to be displayed concurrently with a view of the object on a display screen of the computing device.

2. The method of claim 1, wherein the at least one characteristic of the object comprises at least one of a shape of the object, a size of the object, a color of the object, the position of the object, the temperature/pressure/other sensor reading of the object, orientation or position of the object, generic text disposed on the object, and a generic visual element disposed on the object.

3. The method of claim 1, wherein the category of the object is identified by performing a machine learning process.

4. The method of claim 3, wherein performing the machine learning process comprises accessing or searching a third party or public database based on the at least one characteristic of the object.

5. The method of claim 1, wherein determining the characterizing feature comprises performing a machine learning process.

6. The method of claim 5, wherein performing the machine learning process involves accessing or crawling a third party or public dataset based on the category of the object.

7. The method of claim 1, wherein generating the virtual content comprises performing a machine learning process.

8. The method of claim 1, wherein generating the visual content comprises:
determining a software application based on the category of the object, the software application managing user content configured by the user;
retrieving the user content from the software application; and
generating the virtual content based on the retrieved user content.

9. The method of claim 8, wherein the virtual content comprises the retrieved user content.

10. The method of claim 1, wherein causing the virtual content to be displayed comprises overlaying the view of the object with the virtual content.

11. The method of claim 1, further comprising:
identifying content that is disposed on the object based on the sensor data;
determining a software application based on the category of the object, the software application being accessible by the user on the computing device; and
providing, to the software application, data corresponding to the identified content for use by the software application in modifying application content of the software application.

12. The method of claim 1, wherein the sensor data comprises video or still pictures.

13. The method of claim 1, wherein the user computing device comprises one of a smart phone, a tablet computer, a wearable computing device, a head-mounted display device, a vehicle computing device, a laptop computer, and a desktop computer.

14. The method of claim 1, wherein the receiving, identifying, determining, generating, and causing are performed by a remote server separate from the computing device.

15. A system comprising:
a machine having a memory and at least one processor; and
an object identification module, executable on the at least one processor, configured to perform operations comprising:
receiving sensor data of an object, the sensor data having been captured by a computing device of a user; and
identifying, by a machine having a memory and at least one processor, a category of the object based on at least one characteristic of the object from the sensor data;
a characterizing feature module configured to perform operations comprising determining a characterizing feature of the category of the object; and
a virtual content module configured to perform operations comprising:
generating virtual content based on the characterizing feature; and
causing the virtual content to be displayed concurrently with a view of the object on a display screen of the computing device.

16. The system of claim 15, wherein the at least one characteristic of the object comprises at least one of a shape of the object, a size of the object, a color of the object, an orientation of the object, generic text disposed on the object, and a generic visual element disposed on the object.

17. The system of claim 15, wherein at least one of identifying the category of the object, determining the characterizing feature, and generating the virtual content comprises performing a machine learning process.

18. The system of claim 15, wherein the virtual content module is further configured to perform operations comprising:
determining a software application based on the category of the object, the software application managing user content configured by the user;
retrieving the user content from the software application; and
generating the virtual content based on the retrieved user content.

19. The system of claim 1, wherein the virtual content module is further configured to perform operations comprising:
identifying visual content that is placed with a fixed or dynamic spatial relationship to the object based on the sensor data;
determining a software application based on the category of the object, the software application being accessible by the user on the computing device; and
providing, to the software application, data corresponding to the visual content for use by the software application in modifying application content of the software application.

20. A non-transitory machine-readable storage device, tangibly embodying a set of instructions that, when executed by at least one processor, causes the at least one processor to perform operations comprising:
receiving sensor data of an object, the sensor data having been captured by a computing device of a user;
identifying a category of the object based on at least one characteristic of the object from the sensor data;
determining a characterizing feature of the category of the object;
generating virtual content based on the characterizing feature; and
causing the virtual content to be displayed concurrently with a view of the object on a display screen of the computing device.
